(19) United States
(12) Patent Application Publication
(10) Pub. No.: US 2007/0050279 A1
(43) Pub. Date: Mar. 1, 2007

(54) Reverse bidding for trip services

(75) Inventors: Qingfeng Huang, San Jose, CA (US); Daniel H. Greene, Sunnyvale, CA (US); Juan Liu, Milpitas, CA (US); Hermann Calabria, Mountain View, CA (US)

Correspondence Address: PATENT DOCUMENTATION CENTER, XEROX CORPORATION, 100 CLINTON AVENUE SOUTH, XEROX SQ. 20 TH FLOOR, ROCHESTER, NY, 14644, US

(73) Assignee: Palo Alto Research Center Incorporated

(21) Appl. No.: 11/213,107

(22) Filed: Aug. 26, 2005

(51) Int. Cl. G06Q 99/00; G06Q 40/00

(52) U.S. Cl. 705/37; 705/1

(57) ABSTRACT

A method for reverse bidding of trip services among mobile communication devices. over a communication network is stored and executed as an application for use by network devices. The method includes specifying destination and selection criteria of a vehicle user and developing a trip specification based on the destination and selection criteria. Offers for services are solicited via transmission to an advertising service or directly from service providers, who have received the trip specification. When bids are received for the solicited offers, the trip specification is revised to accommodate the received bids. The revised trip specification is presented to the vehicle user for approval and use in navigating the approved route.

### CROSS REFERENCE TO RELATED APPLICATIONS

The following copending applications, Attorney Docket Number 20041783-US-NP, U.S. application Ser. No. XX/XXX,XXX, filed Aug. 26, 2005, titled “System for Propagating Advertisements for Market Controlled Presentation”, Attorney Docket Number 20041784-US-NP, U.S. application Ser. No. XX/XXX,XXX, filed Aug. 26, 2005, titled “System to Manage Advertising and Coupon Presentation in Vehicles”, and Attorney Docket Number 20041785-US-NP, U.S. application Ser. No. XX/XXX,XXX, filed Aug. 26, 2005, titled “Vehicle Network Advertising System”, are assigned to the same assignee of the present application. The entire disclosures of these copending applications are totally incorporated herein by reference in their entirety.

### INCORPORATION BY REFERENCE

The following U.S. patent publications are fully incorporated herein by reference: U.S. Publication Number 2001/0042038 to Phatak (“Method and System for Conducting an Auction for Resources”); U.S. Publication Number 2002/0032035 to Teshima (“Apparatus and Method for Delivery of Advertisement Information to Mobile Units”); U.S. Publication Number 2002/0194061 to Himmel et al. (“Method and System for Request Based Advertising on a Mobile Phone”); U.S. Publication Number 2003/0003929 to Himmel et al. (“Method and System for Schedule Based Advertising on a Mobile Phone”); and U.S. Publication Number 2004/0215526 to Luo et al. (“Interactive Shopping and Selling Via a Wireless Network”).

### BACKGROUND

This disclosure relates generally to the advertisement of goods and services to mobile units and more specifically to a method for reverse bidding of trip services to mobile units.

Traditionally, roadside billboards have acted as a means for advertising goods and services to travelers, including drivers, walkers, and bikers. This advertising outlet has been frequently used by restaurants, automobile dealers, convenience stores, hotels, hospitals, and other service industries and manufacturers to provide information on services or goods available, as well as the location of the advertiser. These businesses depend on customers responding to roadside advertising or observing the business in close proximity to the roadway. The advent of on-board navigation systems makes it possible for travelers to access databases describing services many miles ahead, and consequently travelers can plan better use of roadside services. However, on board navigation also enables drivers to navigate short distances away from the main route to visit services, but this flexibility is not currently being well exploited. It would be useful to have a method in which service businesses can interact with on board navigation systems and offer discounts, service-time guarantees, and better quality services, to induce travelers to choose their services, and in many cases to induce travelers to change their timing or venture further from their original planned routes to visit these services.

### BRIEF SUMMARY

The disclosed embodiments provide examples of improved solutions to the problems noted in the above Background discussion and the art cited therein. There is shown in these examples an improved method for reverse bidding of trip services among mobile communication devices over a communication network, with the method stored and executed as an application for use by network devices. The method includes specifying destination and selection criteria of a vehicle user and developing a trip specification based on the destination and selection criteria. Offers for services are solicited via transmission to an advertising service or directly from service providers, who have received the trip specification. When bids are received for the solicited offers, the trip specification is revised to accommodate the received bids. The revised trip specification is presented to the vehicle user for approval and use in navigating the approved route.

In another embodiment there is provided a system for reverse bidding of trip services among mobile communication devices over a communication network, in which the system is stored and executed as an application for use by network devices. The system includes a personal information and preference module, which gathers personal information from a vehicle user, and a destination specification module, which provides information on destination and approximate time for arrival. A route planning module develops a trip specification, modifies the trip specification based on received bids for services, and develops a final trip specification. A presentation and approval interface module presents the final trip specification to the vehicle user for review. A solicitation module develops bid requests for services based on the trip specification and reviews received bids for applicability to the trip specification, communication with advertising services and advertisers occurring through a communication module. A navigation module provides navigation guidance along the selected route.

In yet another embodiment there is disclosed a system for reverse bidding of trip services among mobile communication devices over a communication network, in which the system is stored and executed as an application for use by network devices. The system includes capability for specifying destination and selection criteria of a vehicle user and developing a trip specification based on destination and selection criteria. Offers for services are solicited via transmission to an advertising service or directly from service providers, who have been provided with a tentative route plan. Based on bids received from the service providers, the trip specification is revised and presented to the vehicle user for approval. If the vehicle user does not approve the trip specification, alternate trip specifications are developed until a suitable route plan is identified.

In yet another embodiment, there is disclosed a computer-readable storage medium having computer readable program code embodied in the medium causing the computer to perform method steps for reverse bidding of trip services among mobile communication devices over a communication network. The method includes specifying destination and selection criteria of a vehicle user and developing a trip specification based on the destination and selection criteria. Offers for services are solicited via transmission to an advertising service or directly from service providers, who have received the trip specification. When bids are received for the solicited offers, the trip specification is revised to accommodate the received bids. The revised route plan is presented to the vehicle user for approval and use in navigating the approved route.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 illustrates an example embodiment of the vehicle advertising network;

FIG. 2 illustrates one possible embodiment of a computing architecture providing reverse bidding management for a vehicle advertising network;

FIG. 3 illustrates an example embodiment of operation of a reverse bidding capability in mobile vehicles;

FIG. 4 illustrates an embodiment of a system for reverse bidding in mobile vehicles; and

FIG. 5 is a flowchart showing an embodiment of the method for reverse bidding in mobile vehicles.

### DETAILED DESCRIPTION

The system and method described herein uses a reverse bidding mechanism tied to the on board navigation systems of mobile vehicles participating in a vehicle advertising network having a digital context-aware advertisement delivery and presentation framework. After a driver programs the on board navigation system, specifying a destination and other trip preferences, the parameters of the trip are broadcast to service providers along plausible routes. Service providers receiving the broadcast can reverse bid to provide the traveler with such items as gas, food, or accommodations. These service offers are returned to the on board navigation system, which incorporates them for route planning. In this way, the route planned may differ slightly from the shortest or fastest possible route, but only in so far as it is more desirable to the traveler due to the additional quality or lower cost of the services on the alternate route.

Automation is provided for service providers so that they can bid on the trips of many more travelers than will respond to their offers. However, the on board route planning system will discard less useful offers, so that travelers will not receive large numbers of unwanted offers, but rather are presented with a few carefully optimized route choices. An interface may also be provided for travelers to participate in making choices among offers. As the parameters of the trip and the interests of the drivers may change during the trip, new trip plans and interests can be broadcast to interested service providers during the trip as well. While for convenience and brevity in the following discussion a vehicle is described as an automobile moving on a roadway and the traveler may be described as a driver, it is noted that vehicle as used herein includes any mobile entity with a computing device having wireless communication capability, such as a boat, an airplane, or a user carrying a cell phone, as well as an automobile. All are fully contemplated by the specification and scope of the claims herein.

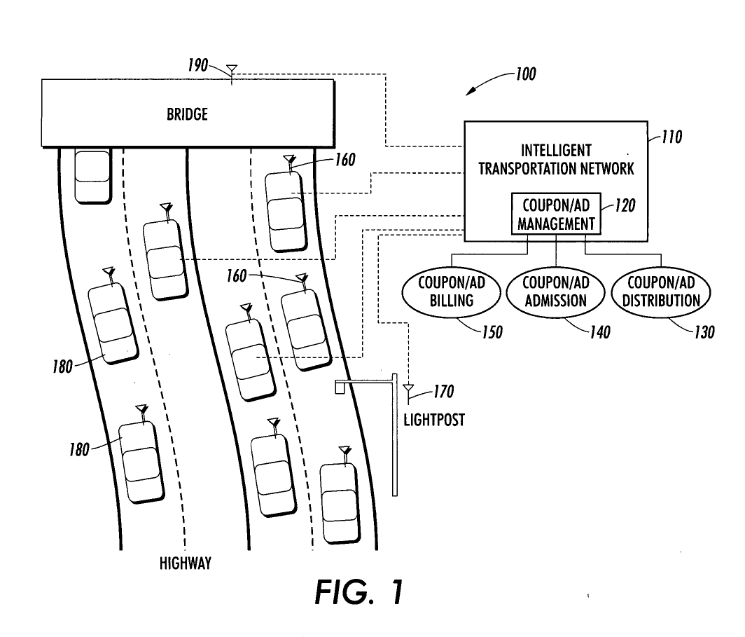

In the following description numerous specific details are set forth in order to provide a thorough understanding of the system and method. It would be apparent, however, to one skilled in the art to practice the system and method without such specific details. In other instances, specific implementation details have not been shown in detail in order not to unnecessarily obscure the present invention. Referring to FIG. 1, the schematic diagram illustrates an example embodiment of the system for vehicle network advertising. Intelligent transportation network 110 may provide various capabilities, such as route information and navigation services, weather information, traffic information, road condition information, neighboring vehicle location, velocity and acceleration information, traffic light signal information, traffic sign information, retail/service location information, and AMBER alert information, among others, as well as advertising management. The server supporting intelligent transportation network 110 may be a general-purpose computer upon which reside the software modules capable of managing system operation. It may also be a system designed specifically for inter vehicle communication into which software modules for coupon/advertisement management have been incorporated.

Within intelligent transportation network 110 resides coupon and advertisement management module 120, which includes coupon/advertisement billing module 150, coupon/advertisement admission module 140, and coupon/advertisement distribution module 130. Coupon/advertisement admission module 140 may perform several functions, including accepting coupons/ads from advertisers with a chosen pricing scheme, determining the initial scope over which each coupon/ad is disseminated, and, optionally, stamping and authenticating the coupons/ads for propagation in the network. Coupon/ad distribution module 130 propagates the coupons/ads in the network according to prescribed scope parameters, such as area and time. Billing module 150 monitors the response of vehicle users to specific coupons and may use that information to compute the cost to the respective advertisers. The billing module may also contain a function to trigger removal of propagation of a coupon/ad in the network, for example, upon request by the advertiser. Network 110 transmits information to participating vehicles 180 either directly or through transmission units 170 and 190 located along a roadway.

While the architecture described in FIG. 1 is independent of the underlying wireless transmission protocols, existing wireless transmission protocols such as DSRC (Dedicated Short Range Communication protocol), IEEE 802.11 (WiFi) may be used. There are no specific transmission protocols required for a vehicle to participate in the network except for the necessity of having a wireless signal reception interface for the chosen signal band and protocol. For intermediary transmission units such as units 170 and 190, both reception and re-transmission capabilities are needed. The intermediary transmission units may receive signals from satellites or cellular towers, using a protocol and wireless media that are different from the one it uses to transmit to vehicles, as well as the protocol it uses to transmit among vehicles. Generally, network transmissions are based on a geographical broadcast, usually targeting vehicles in a specific area. The user does not need to access the central system before information is transmitted.

Various computing environments may incorporate capabilities for supporting an intelligent transportation network. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices.

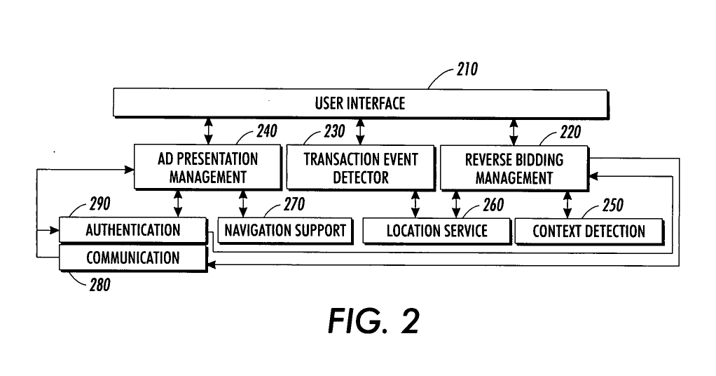

Turning now to FIG. 2, the architecture of the software onboard the vehicle is illustrated. Here, user interface 210 communicates directly with reverse bidding management module 220, transaction event detector 230, and ad presentation management module 240. Reverse bidding management module 220 enables retailers and service providers the opportunity of doing more informed targeting of potential customers as well as enabling them to perform inventory management and sales-pricing in real or near-real time. This is enabled through provision of trip information to the service providers, so that service providers on potential routes have the opportunity to bid on the services/merchandise the traveler might enjoy. A pre-selection procedure or algorithm permits selection among the bidders and generation of preferred route choices from which the user may choose. The system may also inform the respective bidders of the user's choice. For example, a restaurant manager could be provided with the number and arrival time of customers prior to arrival; travelers would have opportunities to plan their route according to available services and service providers' bids on plausible and competing route plans, to obtain more efficient services. Ad presentation management module 240 permits better advertising targeting and more effective use of ad time for advertisers, while travelers receive more relevant ads and avoid advertising overload. This is accomplished through the use of presentation slots, described in more detail in copending U.S. patent application Ser. No. XX/XXX,XXX, Attorney docket number 20041784 (“System to Manage Advertising and Coupon Presentation in Vehicles”).

Transaction event detector 230 receives vehicle location information from location service module 260, which determines location based on GPS data. Location change information may form a basis for detecting a “drive-to” event. Furthermore, a “click” on the items presented on the user interface may form a “click-though” event detected by transaction event detector 230. Detected transaction events, such as a “drive-to” and “click-through” are used later for billing purposes. Context detection module 250 identifies additional information which would be useful for the purposes of targeting advertising. For example, it would determine if a child is present in the vehicle, the number of people in the vehicle, whether the trip is for leisure or business, whether the fuel level is low, the temperature is high, the tire pressure is low, or whether a meal break timing is approaching, etc. This information is then provided to reverse bidding management module 220, which has also received vehicle location information from location service module 260.

Navigation support module 270 assists the driver in navigating the vehicle to specific locations and provides trip information and general area information to ad presentation module 240. Navigation support module 270 includes navigation map and navigation plan (via input from driver.) capability. The navigation maps may include business/service information at each location. Location service module 260 provides vehicle location information to transaction event detector module 230 and reverse bidding management module 220. While for the purposes of discussion modules 260 and 270 are illustrated as being separate modules, their functionality could be combined into a single navigation and location module.

Authentication module 290 checks the signature of the data, which is the data/message/packet arriving from the communication interface, using authentication mechanisms. Any known mechanism for authentication may be employed, for example, checking whether the signature appears among a set of legitimate numeric sequence (provided by the central server). The authenticated ads are passed to ad presentation module 240. Communication module 280 receives ad data and passes it to authentication module 290. In scenarios where no authentication is required, it may pass the received data directly to 240. Additionally authentication module 290 provides authenticated data to reverse bidding management module 220 for reverse bidding management if the incoming data is reverse-bidding data. The reverse bidding management module includes functions such as pre-selecting of potential routes given the user's destination and known preferences, sending bidding request to potential service/merchandise providers on potential routes, grouping the bids from the providers on each route and selecting the best route choices for the user, and instructing the navigation system to set the driving path given the user's choice. Reverse bidding module 220 may send bid choice results to user interface module 210 for the user to make a selection, which then provides the result of route choice and the results of the winning bids/deals/ads and the identifications of the bidders to communication module 280, which provides the information to ad presentation management module 240.

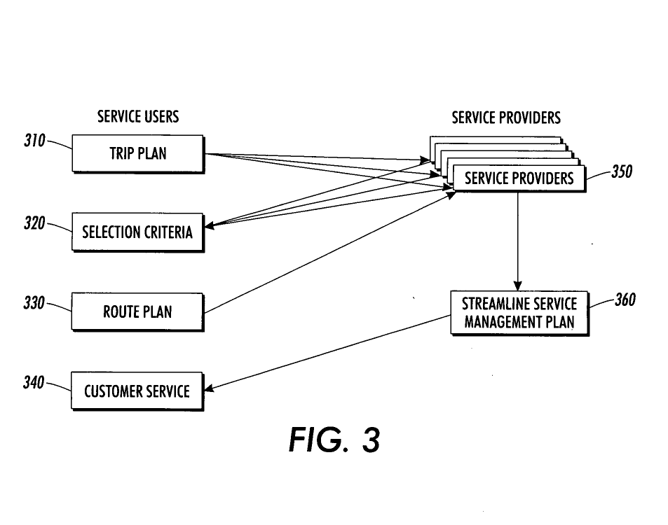

Turning now to FIG. 3, in one embodiment of a vehicle capable of participating in an advertising network having reverse bidding capability, service providers 350 may include businesses such as restaurants, car repair shops, service stations, and numerous other examples. Service providers 350 may also include but are not limited to hospitals, police, and roadside assistance services. Service users, such as motorists, cyclists, or mobile telephone users, provide trip plan 310 to service providers 350. Trip plan 310 may include, for example, information related to destination, desired timing and quality for meals and overnight accommodation, degree of time sensitivity and any deadlines, interest in points of interest along the route, driving speed, degree of spontaneity permitted, price sensitivity to out-of-the-way travel, desirable weather conditions, and vehicle conditions. The trip plan may also include any potentially useful information, such as whether one of the travelers prefers a certain type of computer, or certain types of games. Not all of the trip parameters need to be explicitly specified by the traveler. Some parameters may be predicted from on board sensors, for example, when a vehicle needs to stop for gas. Moreover, some of the parameters can be modeled from past experience: if the traveler seldom travels off-route for price savings, but will visit higher quality services off the main route, this profile can be automatically generated and included in the trip specification.

Details of the trip specification can be useful to service providers devising offers that will be beneficial to the traveler. For example, a traveler with a time deadline might be willing to drive a few minutes off-route for a desired restaurant provided the offer included a service-time guarantee. Similarly, the details of the trip specification may be beneficial to service providers attempting to manage capacity. For example, a restaurant that anticipates being lightly occupied in one hour, might offer deeper discounts to travelers on more distant routes. Other aspects of the trip specifications, such as price sensitivity, would assist the restaurant in predicting the yield of these offers.

Propagation of trip plan 310 may be accomplished by an on board navigation system, which computes plausible routes, and uses these routes to set a geographic scope for the transmission of the trip specification. The trip specification could then be propagated peer-to-peer through DSRC technologies, or more centrally through cellular type technologies such as the G3 technologies. However, it is not necessary for the on board navigation system to compute plausible routes. An alternative architecture provides a trip specification that is generously scoped and propagated in large numbers directly to potential service providers 350. This system relies on the services to perform route-planning computations and check plausibility as part of the process of devising offers for the traveler. Another alternative architecture relies on more centralized servers to compute appropriate scopes for trip specifications and to deliver them to plausible services.

Service providers 350 may utilize numerous strategies to devise offers for the reverse bidding method. One example approach would be to adjust prices by offering discounts to match demand with supply. In this case every traveler near the service would receive the same discount, regardless of their trip plan, and the discount would vary inversely with the utilization of the service, with deeper discounts to increase service utilization. The details of the trip specifications would be useful in determining the amount of the discount and in predicting the response to the offer. Alternative strategies may involve deeper discounts for travelers whose trips are further from the service, deeper discounts to induce travelers to change plans, stopping earlier or later than planned for the service, or guaranteed service offers for travelers with deadlines.

For service providers such as restaurants and accommodations, the more valuable aspect of the reverse bidding method may be the ability to dynamically manage the capacity of the service. In many cases the best results will be achieved if more offers are generated than will be accepted (or can be serviced), but that the offers are “priced” to yield near full utilization of the service. For this reason, automation is important to generate the offers and manage the yield. Reverse bidding automation can develop models that relate the size and type of offer with the amount of trip variation that can be expected from travelers.

The offers are transmitted from service providers 350 to the vehicle's on board navigation system for comparison to selection criteria 320. These offers are incorporated in the route planning using a utility function that is based in part on the original trip specification. So, for example, if a traveler has specified a willingness to travel additional distances to same service costs, this preference would be incorporated into the utility function. Optimization algorithms such as Shortest Path, Branch-and-Bound, and A* can be used to compute the optimal route 330.

The traveler may accept an offer by optionally communicating back to service provider 350, but not all offers will require acceptance. However, it may be advantageous to a service provider to receive an acceptance of an offer. Acceptance enables a service provider to more accurately manage capacity, and because of its value, a service provider may make. enhanced offers and require acceptance in accordance with a streamlined service management plan 360. The acceptance required may be customized to the trip specification. For example, a restaurant may require a reservation from vehicles more than one hour distant, or a hotel may require a guarantee for a late arrival of traffic. Interaction with on board navigation enables a “dynamic” reservation, in which the on board reservation system revises or cancels reservations based on predicted time of arrival, or the traveler allows the service provider to continuously appraise the predicted arrival time of the customer. For example, a restaurant could use predicted arrival to manage a guaranteed service offer by arranging to have a table waiting when a customer arrives, thus enhancing customer service 340.

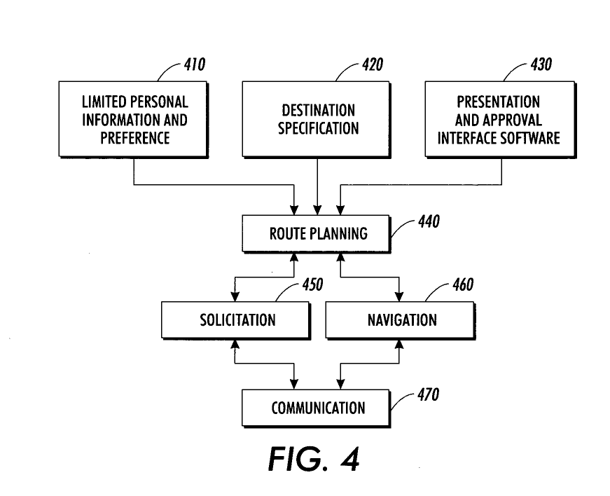

The system for reverse bidding in mobile vehicles is illustrate in FIG. 4. Personal information and preference module 410 gathers information from the user such as desired quality of meals and accommodations, deadlines and degree of time sensitivity, interest in tourist highlights, driving speed, degree of spontaneity, price sensitivity to out-of-the-way travel, and desirable weather conditions and provides it to route planning module 440. Destination specification module 420 provides information on destination, approximate time for arrival, and may include approximate timing for meals and overnight stays, and desirable intermediate stops, for example. Route planning module 440 develops possible routes based on input received from personal information and preference module 410 and destination specification module 420. Additionally, route planning module 440 modifies the tentative trip plan based on received bids for services and develops one or a set of final trip specification(s), which is transmitted to presentation and approval interface 430 for review and selection by the user. Approval interface 430 may also support a command to “widen the search” or “repeat the search for bids”, in which case approval interface 430 may also convey a “search again/widen search” command to route planning module as well. Solicitation module 450 develops bid requests for services based on the tentative trip plan and reviews received bids for applicability to the tentative trip plan and personal information and preference provided in module 410. Navigation module 460 provides for navigation of the chosen route and, optionally, may monitor progress along the route and/or remind the traveler when approaching selected service stops. Communication module 470 communicates with advertising services and advertisers to request and receive bids for services. Additionally, it may report acceptance of offers to advertisers and apprise them of progress along the route.

To illustrate this, a traveler may plan a single-day trip from San Francisco to Los Angeles. The traveler enters the destination (Los Angeles) and preferred driving time span (max 12 hours on the road) into the system via destination specification module 420 and route planning module 440. Route planning module 440 also obtains the traveler's preference information from personal information module 410 and notes that the traveler may prefer Chinese or French food on the trip. Route planning module 440 packages the information and transmits a trip bid solicitation to reverse bidding participating services on three routes: Highways 1, 5, and 101. As service providers on those routes submit their bids, route planning module 440 selects and aggregates the offers on each route according to a set of rules and generates two competing trip plans, one through highway 5 and one through highway 101. While the offers received for meal services appear similar along the two routes, on highway 101 several service stations offer an additional discount on gasoline. Although the original solicitation did not contain a request for gasoline discounts, such discounts are recognized by the system as known cost saving parameters. Route planning module 440 presents two route choices to the traveler through presentation and approval interface 430. The traveler selects one of the routes and route planning module 440 communicates the selected route plan to navigation module 460. The system may also communicate the final selection results to those or a subset of those advertisers who participated in the bidding.

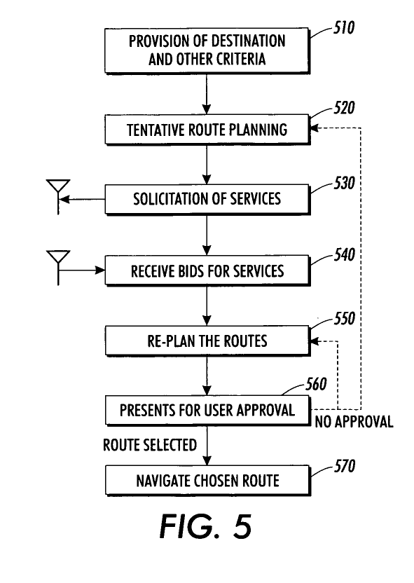

Turning now to FIG. 5, a flowchart illustrates one embodiment of the method for reverse bidding for trip services. At 510 destination and other criteria, such as desired quality and timing of meals and accommodations, deadlines and degree of time sensitivity, interest in tourist highlights, driving speed, degree of spontaneity, price sensitivity to out-of-the-way travel, and desirable weather conditions, are received from the user. With this information, tentative route planning is performed at 520 to generate a set of potential route choices. At 530 services are solicited based on the tentative route via transmission to an advertising service or directly to advertisers. Bids for these services are received at 540 and are evaluated to identify offers of interest for acceptance. Based on the accepted offers, the route is revised at 550. The revised route is presented to the user for approval at 560. If the user does not approve the route, it is returned to 520 for a new route plan. If the user approves the route, the route is finalized at 550. The selected route is then used for navigation purposes at 570. Optionally, the selected route may be reported to service providers to convey acceptance of offers. To protect the privacy of travelers, trip specifications may remain anonymous until offers are accepted by the user. At the point of acceptance or service, the current conventions for privacy would normally allow for a service provider to know the identity of the customer.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer,” as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed:

1. A method for reverse bidding of trip services among mobile communication devices over a communication network, the method stored and executed as an application for use by network devices, the method comprising:
specifying destination and selection criteria of a vehicle user;
soliciting offers for services via transmission to an advertising service or directly from service providers, wherein said advertising service or said service providers are provided said at least one trip specification;
receiving bids for said solicited offers from said service providers;
developing a revised trip specification to accommodate said received bids;
presenting at least one revised trip specification to said vehicle user for approval; and
navigating said approved route plan.

2. The method for reverse bidding of trip services among mobile communication devices according to claim 1, wherein said selection criteria include at least one member selected from the group consisting of quality of meals, accommodations, deadlines and degree of time sensitivity, interest in tourist highlights, driving speed, degree-of spontaneity, sensitivity to out-of-the-way travel, and weather conditions.

3. The method for reverse bidding of trip services among mobile communication devices according to claim 1, wherein said trip specification includes a set of potential route choices.

4. The method for reverse bidding of trip services among mobile communication devices according to claim 1, further comprising evaluating said bids to identify offers of interest based on said trip specification and selection criteria.

5. The method for reverse bidding of trip services among mobile communication devices according to claim 1, further comprising reporting said selected route to said service providers.

6. The method for reverse bidding of trip services among mobile communication devices according to claim 1, wherein said destination criteria include at least one member selected from the group consisting of destination, approximate time for arrival, approximate timing for meals, and desirable intermediate stops.

7. The method for reverse bidding of trip services among mobile communication devices according to claim 1, further comprising monitoring progress along said approved route plan.

8. The method for reverse bidding of trip services among mobile communication devices according to claim 1, further comprising reminding said vehicle user of approaching selected service stops.

9. The method for reverse bidding of trip services among mobile communication devices according to claim 1, further comprising reporting acceptance of said offers to said advertising service or said service providers.

10. A system for reverse bidding of trip services among mobile communication devices over a communication network, the system stored and executed as an application for use by network devices, the system comprising:
personal information and preference module for gathering personal information from a vehicle user;
destination specification module for providing information on destination and approximate time for arrival;
route planning module for developing at least one trip specification, modifying said at least one trip specification based on received bids for services, and developing at least one final trip specification, wherein said final trip specification includes at least one selected route;
presentation and approval interface module for presenting said final trip specification to said vehicle user for review;
solicitation module for developing bid requests for services based on said at least one trip specification and reviewing received bids for applicability to said at least one trip specification;
navigation module for providing navigation of said at least one selected route; and
communication module for communicating with advertising services and advertisers to request and receive bids for services.

11. The system for reverse bidding of trip services among mobile communication devices according to claim 10, wherein said personal information includes at least one member from the group consisting of desired quality of meals, accommodations, deadlines and degree of time sensitivity, interest in tourist highlights, driving speed, degree of spontaneity, sensitivity to out-of-the-way travel, and weather conditions.

12. The system for reverse bidding of trip services among mobile communication devices according to claim 10, wherein said information of destination further includes at least one member selected from the group consisting of destination, approximate time for arrival, approximate timing for meals, and desirable intermediate stops.

13. The system for reverse bidding of trip services among mobile communication devices according to claim 10, wherein developing at least one trip specification comprises selecting possible routes based on input received from said personal information and preference module and said destination specification module.

14. The system for reverse bidding of trip services among mobile communication devices according to claim 11, wherein reviewing said received bids for applicability includes comparing said received bids to said personal information and preferences.

15. The system for reverse bidding of trip services among mobile communication devices according to claim 10, wherein said navigation module further provides monitoring of said vehicle user's progress along said at least one selected route.

16. The system for reverse bidding of trip services among mobile communication devices according to claim 10, wherein said final trip specification further includes identification of selected service stops and intermediate stops along said selected route based on input received from said personal information and preference module and said destination specification module.

17. The system for reverse bidding of trip services among mobile communication devices according to claim 10, wherein said navigation module further provides reminders to said vehicle user when said vehicle user approaches said selected service stops.

18. The system for reverse bidding of trip services among mobile communication devices according to claim 10, wherein said communication module further provides reporting of acceptance of offers to said advertisers or said advertising service.

19. The system for reverse bidding of trip services among mobile communication devices according to claim 18, wherein said communication module further provides apprising said advertisers or said advertising service of said vehicle user's progress along said selected route.

20. A system for reverse bidding of trip services among mobile communication devices over a communication network, the system stored and executed as an application for use by network devices, the system comprising:
means for specifying destination and selection criteria of a vehicle user;
means for soliciting offers for services via transmission to an advertising service or directly from service providers, wherein said advertising service or said service providers are provided at least one trip specification;
means for receiving bids for said solicited offers from said service providers;
means for developing a revised trip specification to accommodate said received bids;
means for presenting said revised trip specification for approval; and
means for navigating said approved route plan.

21. A computer-readable storage medium having computer readable program code embodied in said medium which, when said program code is executed by a computer causes said computer to perform method steps for method for reverse bidding of trip services among mobile communication devices over a communication network, said method comprising:
specifying destination and selection criteria of a vehicle user;
soliciting offers for services via transmission to an advertising service or directly from service providers, wherein said advertising service or said service providers are provided said at least one trip specification;
receiving bids for said solicited offers from said service providers;
developing a revised trip specification to accommodate said received bids;
presenting at least one revised trip specification to said vehicle user for approval; and
navigating said approved route plan.
